(19) United States
(12) Patent Application Publication
(10) Pub. No.: US 2005/0046765 A1
(43) Pub. Date: Mar. 3, 2005

(54) Dual-sided flat panel display structure and operating method thereof

(76) Inventor: Hong-Da Liu, Jubei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/809,121

(22) Filed: Mar. 24, 2004

(30) Foreign Application Priority Data
Sep. 2, 2003 (TW) 92124258

(51) Int. Cl. G02F 1/1335

(52) U.S. Cl. 349/61

(57) ABSTRACT

Dual-sided flat panel display structure and operating method thereof. The disclosed panel can display different images on either side thereof resulting from alternative switch-over of the light sources, combined with image signals which control the images.

### BACKGROUND OF THE INVENTION

1. Field of the Invention

The present invention relates to a flat panel display, and in particular to a dual-sided flat panel display.

2. Description of the Related Art

Cathode ray tube (CRT) displays have reached a development plateau, while other new display technologies have entered the market. Negative effects, such as increase in volume and power consumption, typically occur with development of various display technologies. These structural factors limit the useful applications of CRT displays. With the development of liquid crystal display (LCD) technologies, LCDs have become popular for commercial applications.

Compared to conventional CRT displays, LCDs possess the advantages of lighter weight and smaller profile than CRT displays. LCDs can therefore be more easily carried and conveniently used than conventional CRT displays.

A thin film transistor (TFT) LCD, for example, comprises several key elements such as glass substrates, color filter, polarizing plate, driving ICs, liquid crystal, alignment films, a backlight, and ITO films.

In FIG. 1, a conventional active matrix LCD is shown. Light from a light source module 10 illuminates a polarizing plate 12. The light is polarized as it passes through the polarizing plate 12, followed by passage through a liquid crystal molecule layer 14. The polarization of the liquid crystal molecule layer 14 is controlled by a thin film transistor (TFT) array 22, such that light passing therethrough is polarized and of different intensities. The polarized light then passes through the red, blue, and green pixels on a color filter 16, providing the pixels with different brightness levels and colors. The light from the pixels passes through another polarizing plate 18, forming viewable images for a user 20.

The conventional LCD structure often cannot display images according to increasingly complex user demands. For example, current devices often provide dual displays achieved by adding a second display to the housing thereof. This results in increased product cost.

### SUMMARY OF THE INVENTION

Thus, the object of the present invention is to provide a dual-sided flat panel display and operating method thereof.

In order to achieve the described object, the present invention provides a dual-sided flat panel display and operating method thereof, in which a light source module is provided on either side of a liquid crystal panel. Users on either side of the display can view different images resulting from alternately lighting and switching off the two light source modules at a frequency larger than that of the persistence of vision in a naked human eye and inputting various image signals during the switch-over of the light source modules to control display of the images.

The same cold cathode fluorescent lamp or light emitting diode (LED), or two different cold cathode fluorescent lamps or LEDs may be used by the light source modules. The display is transmissive or semitransmissive LCD with liquid crystal molecules of twisted nematic (TN), super twisted nematic (STN), mixed twisted nematic (MTN), reflective twisted nematic (RTN), reflective super twisted nematic (RSTN), or vertical alignment (VA) type.

### BRIEF DESCRIPTION OF THE DRAWINGS

The present invention can be more fully understood by reading the subsequent detailed description in conjunction with the examples and references made to the accompanying drawings, wherein:

FIG. 1 is a skeleton diagram of a conventional active matrix driven LCD.

FIG. 2 is a skeleton diagram of an active matrix driven LCD of the present invention.

FIGS. 3A through 3C are skeleton diagrams of application of a light source module of the present invention.

FIGS. 4A and 4B are oscillographs illustrating switch-over of light source modules of the first embodiment of the present invention.

FIG. 4C is a chart of signal trends, controlling the arrangement of liquid crystal molecules, which is generated by the TFT array of the first embodiment of the present invention during the switch-over of light source modules.

FIG. 4D is a skeleton diagram of screen sizes viewed on either side of the liquid crystal panel of the first embodiment of the present invention.

FIGS. 5A and 5B are oscillographs illustrating the switch-over of light source modules of the second embodiment of the present invention.

FIG. 5C is a chart of signal trends, controlling the arrangement of liquid crystal molecules, which is generated by the TFT array of the second embodiment of the present invention during the switch-over of light source modules.

FIG. 5D is a skeleton diagram of screen sizes viewed on either side of the liquid crystal panel of the second embodiment of the present invention.

FIGS. 6A through 6F are oscillographs of the switch-over of light source modules of the third embodiment of the present invention.

FIGS. 7A and 7B are skeleton diagrams of a structure of a transmissive LCD.

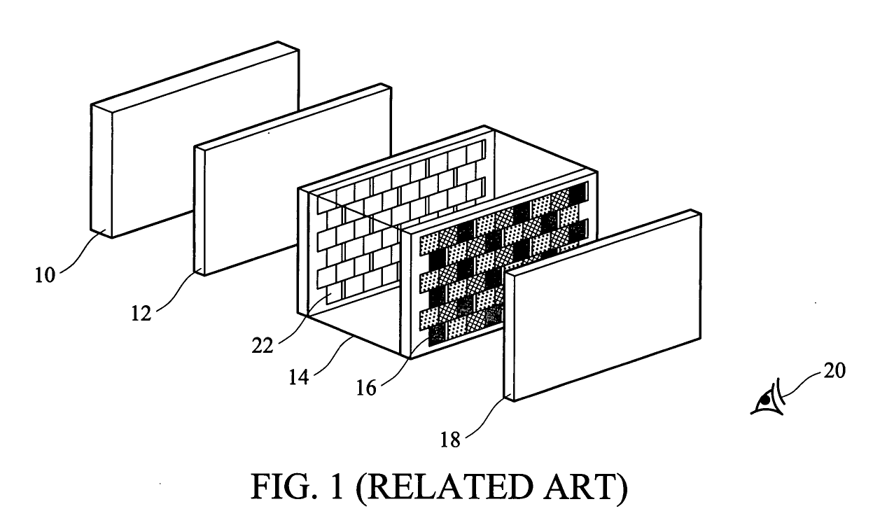

### DETAILED DESCRIPTION OF THE INVENTION

The following embodiments are intended to illustrate the invention more fully without limiting the scope of the claims, since numerous modifications and variations will be apparent to those skilled in this art.

The dual-sided flat panel display and operating method thereof can display different images on either side thereof. Thus, one single panel is equivalent to two conventional panels.

The present invention can be applied to flat panel displays such as a TFT-LCD, STN-LCD, organic light-emitting diode (OLED) display, or an electrophoresis display. The subsequent embodiments use LCDs as an example.

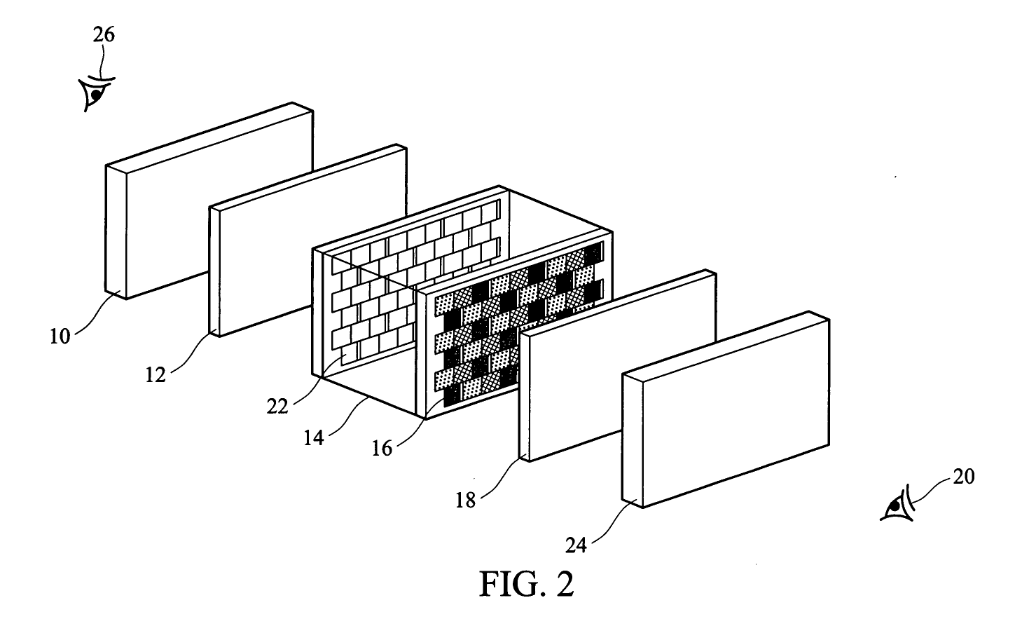

In FIG. 2, a skeleton diagram of a structure of a flat panel display is shown. The flat panel display is an LCD. A main difference between the present invention and the conventional is the application of a second light source module 24 to display images on either side of the LCD resulting from application of two light source modules and imaging sequential technology.

From the point of view of user 26, light from the light source module 24 is received by a polarizing plate 18 and then polarized during passage through the polarizing plate 18, followed by passage through a color filter 16 and liquid crystal molecule layer 14. The light further passes through a polarizing plate 12, and is then seen by user 26.

From the point of view of user 20, light from the light source module 10 is received by a polarizing plate 12 and then polarized during passage through the polarizing plate 12, followed by passage through a liquid crystal molecule layer 14. The light further passes through a color filter 16 and another polarizing plate 18, and is then seen by user 20. Thus, the application of the second light source module 24 enables the panel to display images on either side thereof.

The arrangement of liquid crystal molecules 14 is controlled by a TFT array 22 on a glass substrate. The transmission rate of the polarized light is changed by liquid crystal molecules 14 and polarizing plates 12 and 18, followed by provision of pixels with different brightness levels and colors using red, blue, and green pixels of color filter 16. Note that the TFT array 22 may be replaced by a passive matrix or thin film diode (TFD) matrix to control the arrangement of the liquid crystal molecules 14.

The light source modules may be a cold cathode fluorescent lamp or an LED emitting white light. Further, the light source modules may be an LED emitting red, blue, and green light, or yellow, magenta, and cyan light without color filter 16, and thus, the display show colorful images using color sequential technology. The reaction time of the liquid crystal molecules is less than 20 milliseconds when the light source is white light, but less than 10 milliseconds when the light source is red, blue, and green light, or yellow, magenta, and cyan light, which shows colorful images using color sequential technology.

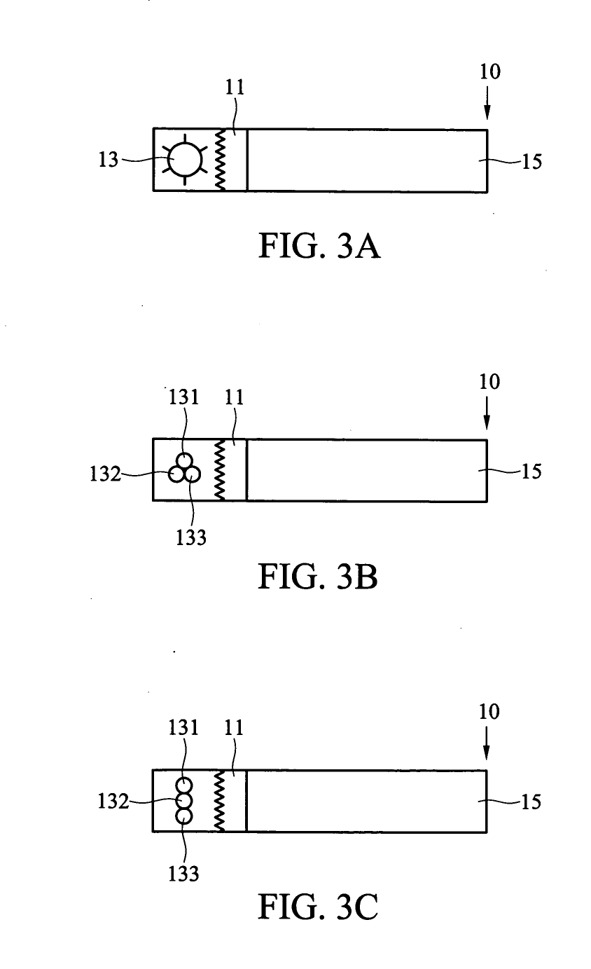

In FIG. 3A, a skeleton diagram of the luminescent principal of a light source module 10 is shown. A cold cathode fluorescent lamp or LED emitting white light provides a light source 13. Light is evenly introduced by a prism 11 and light guide 15. When the cold cathode fluorescent lamp or LED emitting red, blue, and green light or yellow, magenta, and cyan light provides the light source 13, the arrangement thereof is shown in FIGS. 3B and 3C, comprising red light emitting cold cathode fluorescent lamp 131 or a red LED, blue light emitting cold cathode fluorescent lamp 132 or a blue LED, and green light emitting cold cathode fluorescent lamp 133 or green LED. Further, the two light source modules may be provided by the same cold cathode fluorescent lamp or LED, or different cold cathode fluorescent lamps or LEDs.

Thus, images can be displayed on either side of the LCD. Further, the LCD of the present invention can further display different images on either side of the panel resulting from the adjustment of lighting and off times of light source modules 10 and 24, application of imaging sequential technology, and the control of the arrangement of liquid crystal molecules 14 using TFT array 22 on a glass substrate. Lighting time of the both light source modules must be less than 24 milliseconds.

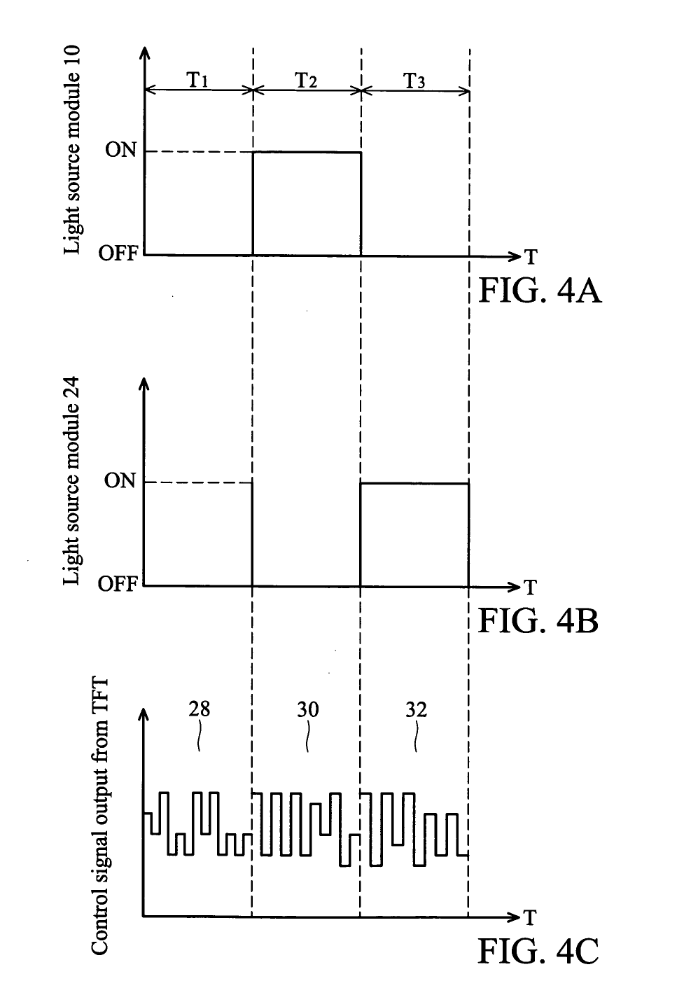

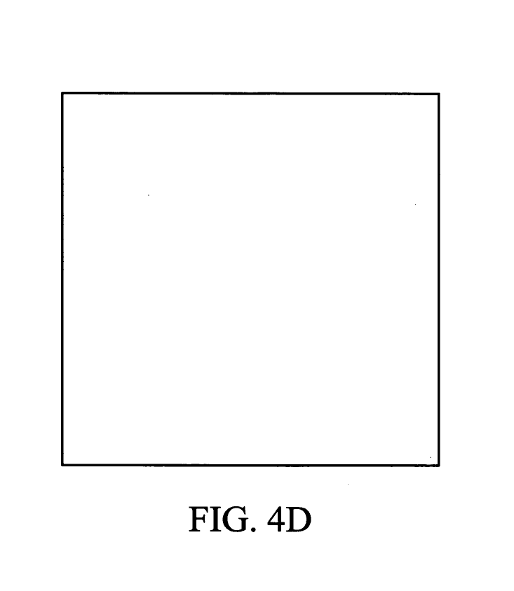

In FIGS. 4A and 4B, oscillographs of the switch-over signals of light source modules of a preferred embodiment of the present invention are shown, wherein the X-axis indicates the switch-over time and the Y-axis indicates the input of switch-over signals. Note that the switch-over time of light source modules 10 and 24 must be less than the time of the persistence of vision in the human eye, which is approximately 24 milliseconds. A User on either side of the panel can view a different image resulting from the alternating switch-over of the light source modules 10 and 24, the persistence of vision in the human eye, and various image signals from the TFT array 22 on a glass substrate to control images on the panel. Note that the TFT array 22 may be replaced by a passive matrix or TFD matrix for controlling the arrangement of the liquid crystal molecules 14.

For example, FIG. 4C is a skeleton diagram of the signals from a TFT array for controlling images during the switch-over of light source modules 10 and 24. Referring to FIGS. 2 and 4A through 4C, in this embodiment, the light source module 24 is lit and a signal 28 is output from the TFT array to control images on the panel during time T1. At the same time, user 26 can view images on the left side of the panel. Next, the light source module 24 is switched off, light source module 10 is lit, and a signal 30 is output from the TFT array to control images on the panel during time T2. Thus, user 20 can see images on the right side of the panel. Then, the light source module 10 is switched off, the light source module 24 is lit again, and a signal 32 is output from the TFT array 22 to control images on the panel during time T3. Thus, user 26 can view images on the left side of the panel. The screen sizes viewed from the left side and right side of the panel are approximately the same and as that shown in FIG. 4D, hence the times T1 through T3 are approximately the same, which are controlled to be less than the length of the persistence of vision in the human eye.

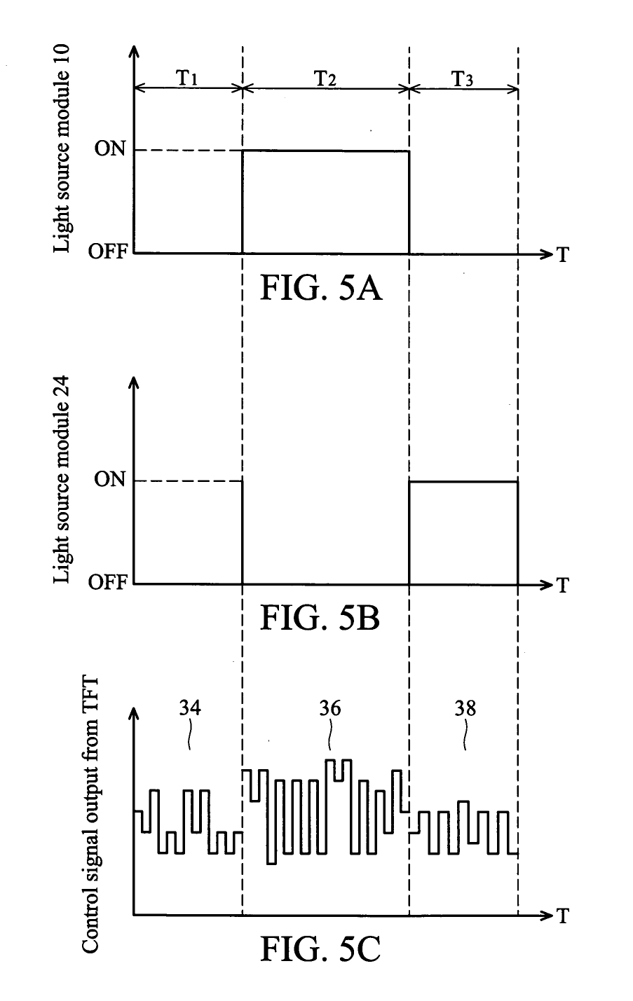

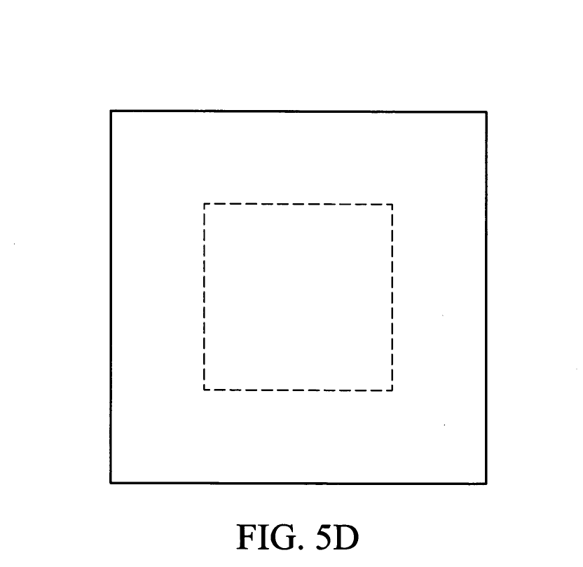

In another embodiment of the present invention, a main image and a secondary image with different sizes can be provided resulting from the input of different image signals. In FIGS. 5A and 5B, oscillographs of the switch-over signals of light source modules 10 and 24 of the second embodiment of the present invention are shown, wherein the X-axis indicates the switch-over time and the Y-axis indicates the switch-over signals. In this embodiment, a main image and a secondary image with different sizes are displayed on either side of the panel, and thus, the inputting signal quantities and switch-over times respectively thereof are different. Note that the switch-over time of light source modules 10 and 24 must be less than the length of the persistence of vision effect in the human eye, of approximately 24 milliseconds.

FIG. 5C is a skeleton diagram of the signals from a TFT array for controlling images during the switch-over of light source modules 10 and 24. Referring to FIGS. 2 and 5A through 5C, in this embodiment, the light source module 24 is lit and a signal 34 is output from the TFT array for controlling images on the panel during time T1. Thus, user 26 can view images on the left side of the panel. Next, the light source module 24 is switched off, light source module 10 is lit, and a signal 36 is output from the TFT array to control images on the panel during time T2. Thus, user 20 can view images on the right side of the panel. Then, the light source module 10 is switched off, the light source module 24 is lit again, and a signal 38 is output from the TFT array to control images on the panel during time T3. Thus, user 26 can view images on the left side of the panel. Display of different image sizes requires different image data, hence, different switch-over times, determined according to different screen sizes, make the TFT array output image sequence have different signals with different data quantity and switch-over time. The screen sizes viewed on the left and right sides of the panel are shown in FIG. 5D, wherein the ranges in the dotted line and solid line respectively indicate screen sizes during times T1 and T2. The screen sizes are different, hence switch-over time of the screen with less signal data may be shortened. Note that the ratio of the output time of the image signal between the screens is between ⅓ and 3 and the lighting time of both light source modules must be less than 24 milliseconds.

The described two light source modules can be cold cathode fluorescent lamps or LEDs emitting white light. Or else, the described two light source modules can be LEDs emitting red, blue, and green light or yellow, magenta, and cyan light without color filter 16.

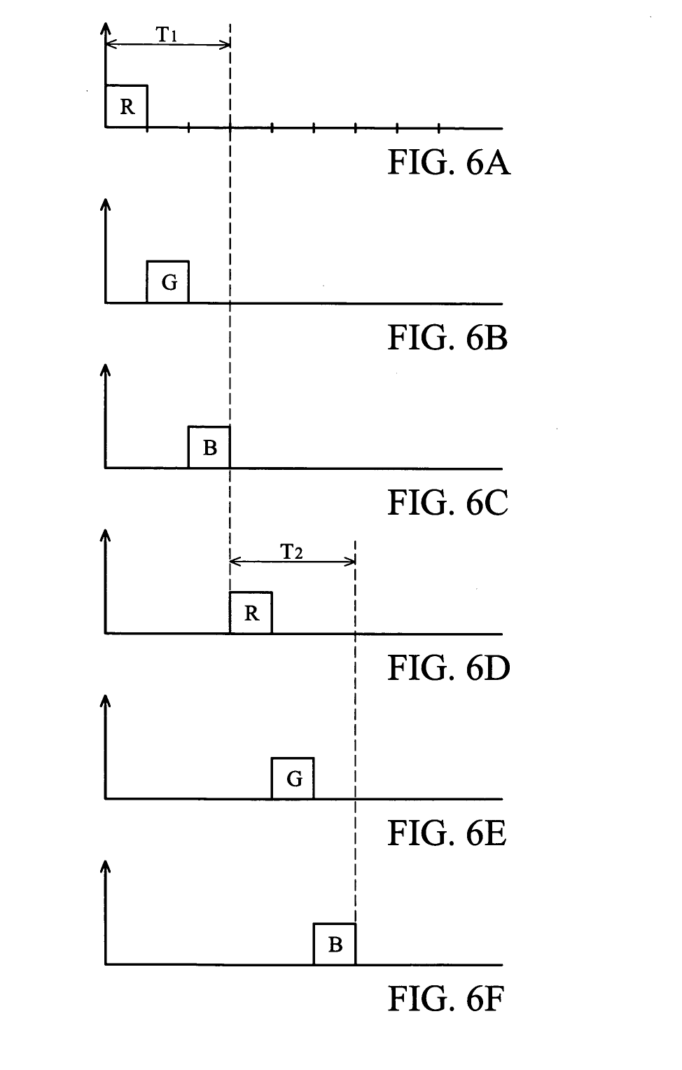

When cold cathode fluorescent lamps or LEDs emitting red, blue, and green lights, or yellow, magenta, and cyan lights are used, an image may be displayed by respectively lighting the red, blue, and green lights when lighting the light source module, followed by perceived mixture of colors by the human eye using color sequential technology. The lighting frequency of the light source module is shown in FIGS. 6A through 6F, wherein the X-axis indicates the switch-over time and the Y-axis indicates the input of the switch-over signal. In this embodiment, reaction time of the liquid crystal molecules is less than 10 milliseconds. A user on either side of the panel can view different images resulting from the alternative switch-over of light source modules 10 and 20, the persistence of vision effect in the human eye, and various image signals from the TFT array 22 on a glass substrate to control images on the panel. Note that the TFT array 22 may be replaced by a passive matrix or TFD matrix to control the arrangement of the liquid crystal molecules 14.

For example, in FIGS. 2 and 6A through 6F, in this embodiment, the red, green, and blue light sources of the light source module 24 are respectively lit and a signal 28 is output from the TFT array to control images on the panel during time T1. Thus, user 26 can view images on the left side of the panel. Next, the light source module 24 is switched off, the red, green, and blue light sources of light source module 10 are respectively lit, and a signal 30 is output from the TFT array to control images on the panel during time T2. Thus, user 20 can view images on the right side of the panel. Users on the left and right sides of the panel can view images resulting from respectively lighting red, blue, and green lights due to the lighting frequency of the light source module and the mixture of colors perceived by the human eye. Similarly, the ratio of the output time of the image signal between two screens respectively with different sizes is between ⅓ and 3. The length of time of the red, green, and blue lights remain lit must be respectively less than 8 milliseconds.

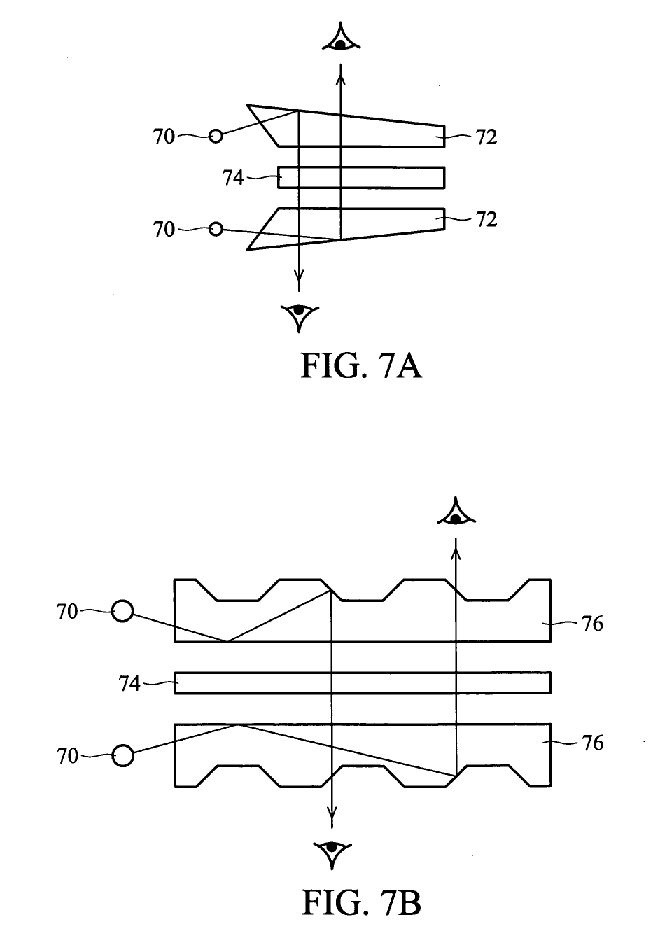

Note that the LCD can be transmissive or semitransmissive. In FIG. 7A, a skeleton diagram of a transmissive LCD is shown. A light source 70 introduces a light from two light source modules 70 into a transmissive LCD structure 74. Because LCD structure 74 is transmissive, the light is not reflected. In FIG. 7B, a skeleton diagram of another transmissive LCD is shown. A light source 70 introduces a light from another two light source modules 70 into a transmissive LCD structure 74. The liquid crystal molecules can be TN, STN, MTN, RTN, RSTN, or VA type.

As described, the LCD structure and operating method thereof of the present invention can display different images on either side of a panel thereof, effectively making a single panel two conventional panels, thereby achieving the described objects of the present invention.

Although the present invention has been particularly shown and described with reference to the preferred specific embodiments and examples, it is anticipated that alterations and modifications thereof will no doubt become apparent to those skilled in the art. It is therefore intended that the following claims be interpreted as covering all such alteration and modifications as fall within the true spirit and scope of the present invention.

1. A dual-sided flat panel display structure, comprising:
two sets of light source modules;
two polarizing plates between the light source modules;
a first and second substrates between the polarizing plates;
a driving array at an inner side of the first substrate; and
light valve device between the first substrate and second substrates.

2. The structure as claimed in claim 1, further comprising a color filter between the polarizing plates.

3. The structure as claimed in claim 1, wherein screen sizes on either side thereof are the same or different.

4. The structure as claimed in claim 1, wherein the flat panel display is a liquid crystal display (LCD).

5. The structure as claimed in claim 1, wherein the driving array comprises a thin film transistor (TFT) array.

6. The structure as claimed in claim 1, wherein the driving array comprises a passive matrix driving array.

7. The structure as claimed in claim 1, wherein the driving array comprises a thin film diode (TFD) array.

8. The structure as claimed in claim 1, wherein the flat panel display is a STN-LCD.

9. The structure as claimed in claim 1, wherein the flat panel display is an organic light-emitting diode (OLED) display.

10. The structure as claimed in claim 1, wherein the flat panel display is an electrophoresis display.

11. The structure as claimed in claim 1, wherein the light source modules are provided by the same light source.

12. The structure as claimed in claim 1, wherein the light source modules are provided by different light sources.

13. The structure as claimed in claim 1, wherein the light source of the light source modules is LEDs.

14. The structure as claimed in claim 1, wherein the light source of the light source modules is cold cathode fluorescent lamps.

15. The structure as claimed in claim 1, wherein the light source comprises red light, blue light, and green light.

16. The structure as claimed in claim 1, wherein the light source comprises yellow light, magenta light, and cyan light.

17. The structure as claimed in claim 1, wherein the light source is white light source.

18. An operating method of a dual-sided flat panel display having a first and second light source modules, two substrates between the first and second light source modules, and a driving array on an inner side of the first substrate, comprising:
(a) lighting the first light source module;
(b) outputting a first image signal from the driving array to control a first display of a first image;
(c) switching off the first light source module, followed by lighting the second light source module;
(d) outputting a second image signal from the driving array to control a second display of a second image;
(e) switching off the second light source module, followed by lighting the first light source module; and
(f) repeating steps (b) through (e).

19. The method as claimed in claim 18, wherein the driving array comprises a of thin film transistor (TFT) array.

20. The method as claimed in claim 18, wherein the driving array comprises a passive matrix driving array.

21. The method as claimed in claim 18, wherein the driving array comprises a thin film diode (TFD) array.

22. The method as claimed in claim 18, wherein the flat panel display is a STN-LCD.

23. The method as claimed in claim 18, wherein the flat panel display is an organic light-emitting diode (OLED) display.

24. The method as claimed in claim 18, wherein the flat panel display is an electrophoresis display.

25. The method as claimed in claim 18, wherein the first and second light source modules are provided by the same light source.

26. The method as claimed in claim 18, wherein the first and second light source modules are provided by different light sources.

27. The method as claimed in claim 18, wherein the light source of the light source modules is LEDs.

28. The method as claimed in claim 18, wherein the light source of the light source modules is cold cathode fluorescent lamps.

29. The method as claimed in claim 18, wherein the light source is white light source.

30. The method as claimed in claim 18, wherein the light source comprises red, blue, and green light.

31. The method as claimed in claim 18, wherein the light source comprises yellow, magenta, and cyan light.

32. The method as claimed in claim 18, wherein the length of time the first and second light source modules are lit is less than 24 milliseconds.

33. The method as claimed in claim 18, wherein a ratio of the length of time the first light source module is lit to that of the second light source module is between 3 and ⅓.

34. The method as claimed in claim 18, wherein the first and second signals display different images.

35. The method as claimed in claim 18, wherein a reaction time of a liquid crystal molecule is shorter than 20 milliseconds when using white light as a light source.

36. The method as claimed in claim 18, wherein a reaction time of a liquid crystal molecule is shorter than 10 milliseconds when using red, blue, and green light as light sources.

37. The method as claimed in claim 18, wherein the first and second signals display images using imaging sequential technology.

38. The method as claimed in claim 18, wherein the first and second signals display images using color sequential technology.
